(19) United States
(12) Patent Application Publication
(10) Pub. No.: US 2006/0260655 A1
(43) Pub. Date: Nov. 23, 2006

(54) Asbestos removal process

(76) Inventors: William R. Martin, Fair Play, SC (US); Carl W. Martin, Jefferson, GA (US)

Correspondence Address: John B. Hardaway, III;NEXSEN PRUET, LLC, P.O. Box 10107, Fed Sta., Greenville, SC, 29603-0107, US

(21) Appl. No.: 11/135,051

(22) Filed: May 23, 2005

(51) Int. Cl. B08B 3/00

(52) U.S. Cl. 134/34

(57) ABSTRACT

An improved process of removing asbestos. The process includes applying a foam to the asbestos. The asbestos is removed, prior to the foam draining, and encased in a storage device.

### BACKGROUND OF THE INVENTION

The present invention is related to an improved process for asbestos removal. More particularly the present invention is related to the application of non-reactive foam to asbestos prior to removal wherein the adhesive readily adheres to the asbestos and prohibits dislodged particles from becoming airborne.

For many years asbestos was a material of choice within the building industry as a sound and thermal insulator. The properties of asbestos are well documented and further elaboration is not necessary herein. One problem with asbestos is the propensity for dislodged particles to become airborne wherein they are susceptible to being inhaled by occupants of the building. After many years it was determined that the inhaled particles can be detrimental to ones health and, in fact, the disease created by inhalation of asbestos is now commonly referred to as asbestosis. Unfortunately, by the time the hazards of asbestos were discovered it was the predominant material in such diverse applications as pipe wrap, flooring material, wall material and bulk insulation just to name a few. Particle abatement was therefore considered to be a major problem.

Those of skill in the art are left with two solutions for dealing with asbestos neither of which is totally satisfactory. One solution is to contain the particles and the other is to remove the asbestos or asbestos containing material. There are many teachings related to permanent sealants for asbestos containing materials. These clearly are advantageous when the asbestos is to be left in place. Removing the asbestos has proven to be a substantial problem since virtually any removal process involves abrading the asbestos thereby increasing the rate at which particles are dislodged. The more the structure is disrupted, or broken apart, the higher the propensity for dusting. Even sealed asbestos is eventually removed therefore the removal process occurs for virtually all asbestos containing products.

There have been many reports of techniques for the safe removal of asbestos. These can be broadly characterized as mechanical techniques and chemical techniques. Mechanical techniques utilize some form of area containment in combination with a pressure differential or flowing medium to either contain the particles or entrain them in the stream of flowing medium. These techniques are extremely difficult and costly to implement but have been the method of choice for most applications.

Chemical techniques have been discussed wherein the asbestos is either chemically modified or coated prior to removal. These techniques are also lacking. Acids, and particularly fluorides, are known to convert asbestos to a non-asbestos material. Chemical modification of the asbestos has been exploited in various forms as illustrated in U.S. Pat. Nos. 6,589,156; 5,743,841; 5,516,973 and 5,439,322. The difficulty of utilizing strong acid solutions in a closed environment would be readily realized to one of skill in the art. It would especially be apparent that a stoichiometric volume of a strong acid necessary to remove asbestos from a large area would create an additional hazard and require a substantial volume of solvent.

Various efforts have been reported for coating the asbestos prior to removal. U.S. Pat. No. 4,857,085 teaches vaporization of cyanoacrylate to form a hard film on the asbestos prior to dismantling the asbestos. This technique is adequate for encapsulating the visible surface of the asbestos but it is not sufficient to cover areas which break during removal. Therefore, a hard film is inadequate to solve the problems associated with airborne particles.

U.S. Pat. No. 4,693,755 describes formation of a cellulosic polymer which is applied to the asbestos. The cellulosic polymer is allowed to penetrate and the asbestos is removed while still wet. This technique has an advantage in that the polymer is somewhat mobile but it is still inferior for covering newly exposed areas of the asbestos. Furthermore, the problem associated with large volumes of solvent remains.

In summary, the art has been seeking a method for safely removing asbestos which does not require large volumes of solvent, adequately protects surfaces as they become exposed, and which is economical.

### SUMMARY OF THE INVENTION

It is an object of the present invention to provide a system for asbestos removal.

It is another object of the present invention to provide a system for asbestos removal which adequately covers newly exposed asbestos resulting from the removal process.

Yet another object of the present invention is to provide a system for asbestos removal which eliminates solvents thereby substantially reducing the total volume of material which must be cleaned after removal of the asbestos.

A particular feature is the ability to utilize materials which are safe to handle, readily available, easily dispensed and economical.
These and other advantages, as will be realized, are provided in an improved process of removing asbestos. The process includes applying a foam to the asbestos. The asbestos is removed, prior to the foam draining, and encased in a storage device.
Yet another embodiment is provided in a process for removing asbestos from a support structure. The process includes applying a non-reactive foam to the asbestos and separating the asbestos from the support structure prior to the foam draining.
Yet another embodiment is provided in a process for removing asbestos from a support structure. The process includes applying a foam to the asbestos wherein the foam has a pH of 5 to 9. The asbestos is separated from the support structure, prior to the foam draining, and encased in a storage device.

### BRIEF DESCRIPTION OF THE FIGURES

FIG. 1 illustrates the application of foam to a surface.

FIG. 2 illustrates the separation of a subsection from a surface.

FIG. 3 illustrates the partial removal of a subsection area from a larger area.

FIG. 4 illustrates a removed subsection area and remaining larger area.

### DETAILED DESCRIPTION OF THE INVENTION

The present invention is specific to the use of a foam which is applied to the asbestos prior to removal. The foam has the advantage of covering a large area with minimal amount of material. As the asbestos is subsectioned the foam easily conforms and migrates to newly exposed surfaces.

The invention will be described with reference to the figures forming an integral non-limiting part of the instant disclosure.

For the purposes of the present invention foam is defined as a non-reactive dispersion of a gas or vapor in a liquid. The drain time, or time required for the foam to decompose into the original liquid and gas phases, should be sufficiently long to allow for the asbestos to be removed and transported to a contained environment without substantial loss of foam.

A foam production system typically includes a foam precursor, or pre-foamed liquid, an expansion gas and equipment capable of combining, mixing and discharging the foam.

The foam precursor is preferably a liquid with a surface tension sufficient low to form a foam. The surface tension is preferably below about 30 dynes/cm and can be lowered by incorporation of suitable surfactants. Water based systems are suitable but organic based foams are most preferred. The foam preferably has a near neutral pH of around 5-9 and more preferably around 6-8. The foam is preferably thixotropic with a viscosity that is shear dependent. In the absence of shear force the foam will not flow and can be stacked or piled to depth if desired. It is most preferred that the foam precursor be substantially non-reactive with asbestos. While not limited thereto a particularly preferred foam is Bilmar Foam, product code 12-530 available from IPC Supply, Inc. of Anderson, S.C.

The expansion gas can be air however other expansion gas systems are known to be useful such as low molecular weight hydrocarbons, nitric oxide or carbon dioxide. Air is preferred due to the low cost, low toxicity and the fact that a separate tank is not necessary. It is most important that the expansion gas be non-soluble in the foam precursor.

The foam precursor may have adjuvants as known in the art including surfactants such as sodium lauryl sulfate; stick or adhesive additives such as styrene-butadiene polymer; thickeners or viscosity modifiers such as typical paint thickeners, gelatin or modified starches; and others.

Foam generating equipment is well documented and not particularly limiting herein. The foam generating equipment has two main components. One component combines the liquid foam precursor with the expansion gas. The mixing is preferably very thorough to insure the drain time is sufficiently long and that the expansion is optimum. The mixing can be done by passing through a hose, or pipe, with sufficient flow turbulance to mix the components. Alternatively, the mixture can be passed through a mixing device such as a packed bed mixture.

During use, a section of asbestos to be removed is completely covered with foam. A subsection of asbestos is then typically separated from the larger section by cutting or otherwise breaking the asbestos into subsections within the boundary of the foam covering. Alternatively, the asbestos is separated from a support structure. One advantage of the foam is that the cutting can occur through the foam and as the cutting element is withdrawn the foam heals thereby maintaining a continuous coating. As the subsection is withdrawn the foam begins to elongate and as it breaks the foam naturally collapses to cover both exposed edges from the cutting operation. This ability to stretch, heal and collapse over the newly formed edges provides a benefit not available from prior art techniques. As would be realized the asbestos is removed prior to the foam draining.

After the asbestos is removed it is preferable to encase the asbestos in a storage device, such as sealed plastic, to avoid particles becoming airborne during transport and delivery. It would be readily apparent that it is most preferable to encase the removed asbestos prior to the foam draining.

The process of asbestos removal will be described with reference to the figures. In the various figures similar elements are numbered accordingly.

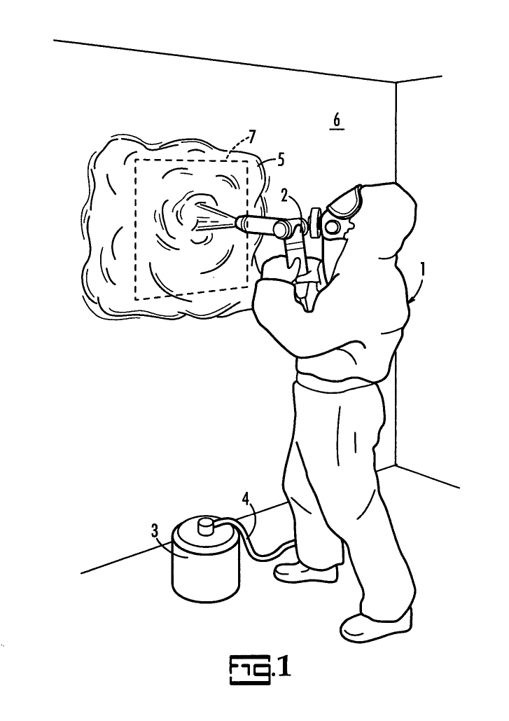

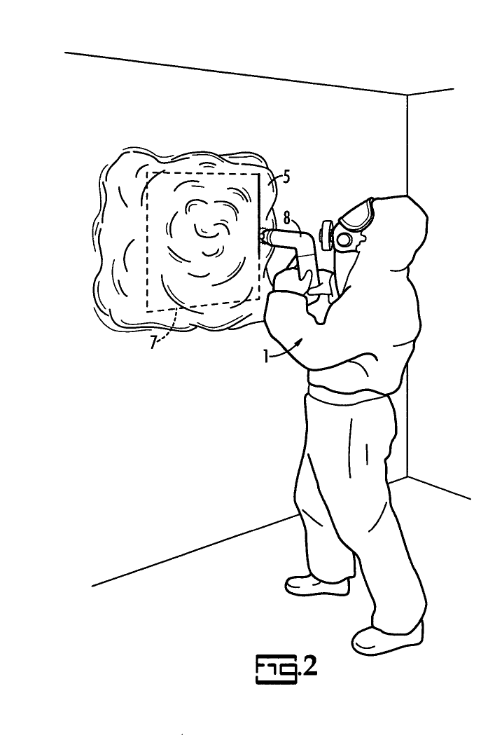

Application of the foam is illustrated in FIG. 1. In FIG. 1 a user, 1, activates a nozzle, 2, which receives foam precursor and expansion gas from a foam generator, 3, via a hose, 4. The foam, 5, is applied to a surface, 6. If the entire surface is to be removed intact foam is applied to the edges of the surface as would be realized from the disclosure herein. It is most common to remove a subsection, 7, of the surface, 6, by cutting or otherwise forming a separation between the surface and the subsection. A rotary tool, 8, is particularly suitable for cutting the subsection from the surface as illustrated in FIG. 2. As the rotary tool enters and is withdrawn the foam extends and then collapses to heal thereby providing a near continuous seal before, during and after the cutting operation.

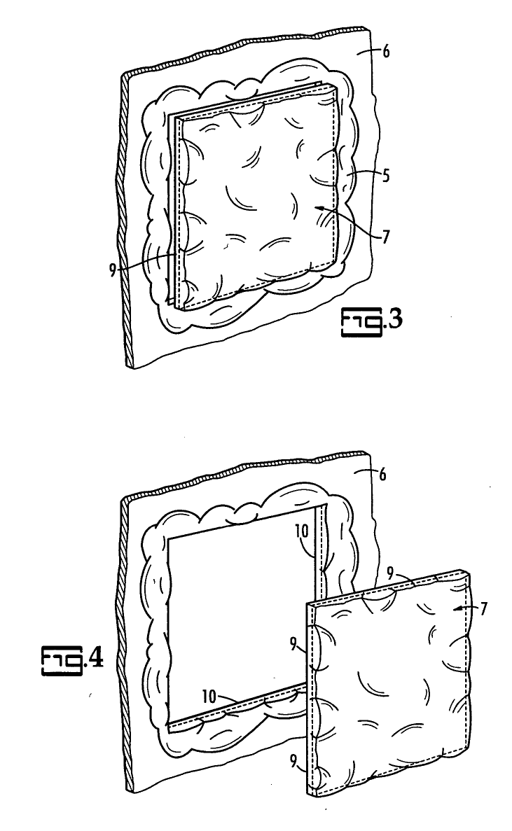

A subsection partially removed from the surface is illustrated in FIG. 3. As the subsection is removed the foam, 5, elongates and, due to the thixotropic properties, eventually collapses thereby covering the edge of the subsection, 9, and the edge of the surface, 10, illustrated in FIG. 4. The user would then continue to apply foam to a second subsection for separation from the surface.

The invention has been described with particular emphasis on the preferred embodiments without limit thereto. Based on the foregoing description other embodiments and alterations would be apparent without departing from the scope of the invention which is more specifically set forth in the claims appended hereto.

Claimed is:

1. A process of removing asbestos comprising:
applying a foam to said asbestos;
prior to said foam draining removing said asbestos; and
encasing said asbestos in a storage device.

2. The process of removing asbestos of claim 1 wherein said asbestos is a subsection of a larger asbestos section.

3. The process of removing asbestos of claim 1 wherein said foam has a pH of at least 5 to no more than 9.

4. The process of removing asbestos of claim 1 wherein said foam is thixotropic.

5. The process of removing asbestos of claim 1 wherein said foam does not react with said asbestos.

6. The process of removing asbestos of claim 1 wherein said foam has a foam precursor and an expansion gas.

7. The process of removing asbestos of claim 6 wherein said expansion gas is air.

8. The process of removing asbestos of claim 6 wherein said foam precursor has a surface tension of less than 30 dynes/cm.

9. The process removing asbestos of claim 6 wherein said expansion gas is insoluble in said foam precursor.

10. A process for removing asbestos from a support structure comprising:
applying a non-reactive foam to said asbestos; and
separating said asbestos from said support structure prior to said foam draining.

11. The process of removing asbestos of claim 10 wherein said asbestos is a subsection of a larger asbestos section.

12. The process of removing asbestos of claim 10 wherein said foam has a pH of at least 5 to no more than 9.

13. The process of removing asbestos of claim 10 wherein said foam is thixotropic.

14. The process of removing asbestos of claim 10 wherein said foam has a foam precursor and an expansion gas.

15. The process of removing asbestos of claim 14 wherein said expansion gas is air.

16. The process of removing asbestos of claim 14 wherein said foam precursor has a surface tension of less than 30 dynes/cm.

17. The process removing asbestos of claim 14 wherein said expansion gas is insoluble in said foam precursor.

18. A process for removing asbestos from a support structure comprising:
applying a foam to said asbestos wherein said foam has a pH of 5 to 9;
separating said asbestos from said support structure prior to said foam draining; and
encasing said asbestos in a storage device.

19. The process for removing asbestos of claim 18 wherein said foam has a pH of 6 to 8.

20. The process of removing asbestos of claim 18 wherein said asbestos is a subsection of a larger asbestos section.

21. The process of removing asbestos of claim 18 wherein said foam is thixotropic.

22. The process of removing asbestos of claim 18 wherein said foam does not react with said asbestos.

23. The process of removing asbestos of claim 18 wherein said foam has a foam precursor and an expansion gas.

24. The process of removing asbestos of claim 23 wherein said expansion gas is air.

25. The process of removing asbestos of claim 23 wherein said foam precursor has a surface tension of less than 30 dynes/cm.

26. The process removing asbestos of claim 23 wherein said expansion gas is insoluble in said foam precursor.
